(19) United States
(12) Patent Application Publication
(10) Pub. No.: US 2024/0028720 A1
(43) Pub. Date: Jan. 25, 2024

(54) SECURE BLOCK CLONING ON RESILIENT FILE SYSTEMS

(71) Applicant: VMWARE, INC., Palo Alto, CA (US)

(72) Inventor: AMIT ANANDRAM LUNIYA, Pune (IN)

(21) Appl. No.: 17/979,065

(22) Filed: Nov. 2, 2022

(30) Foreign Application Priority Data
Jul. 25, 2022 (IN) 202241042510

(51) Int. Cl. G06F 21/56; G06F 21/57

(52) U.S. Cl. CPC G06F 21/565; G06F 21/57

(57) ABSTRACT

To implement secure block cloning on file systems that support block cloning, a computer security application is executed on a computer system deploying a file system that supports block cloning. The computer security application receives a block cloning command to clone a source file to a target file. Before the computer system executes the block cloning command, the computer security application identifies a trust status associated with the source file. The trust status is identified by looking up a base inventory that stores trust data associated with multiple files stored on the file system. The multiple files include the source file. Based on the trust status associated with the source file, the computer security application determines that the trust status associated with the source file is trustworthy. In response to determining that the source file is trustworthy, the computer security application applies the trust status associated with the source file to the target file.

### RELATED APPLICATIONS

Benefit is claimed under 35 U.S.C. 119(a)-(d) to Foreign Application Serial No. 202241042510 filed in India entitled “SECURE BLOCK CLONING ON RESILIENT FILE SYSTEMS”, on Jul. 25, 2022, by VMware, Inc., which is herein incorporated in its entirety by reference for all purposes.

### TECHNICAL FIELD

This disclosure relates to block cloning files on resilient file systems (ReFS) and more generally on file systems that have resiliency characteristics similar to ReFS.

### BACKGROUND

ReFS is a file system introduced by Microsoft Corporation. ReFS can maximize data availability. ReFS can scale efficiently to large data sets across diverse workloads. ReFS can provide data integrity with resiliency to corruption. Block cloning is a process of copying data on ReFS. A block cloning command instructs ReFS to copy a range of file bytes on behalf of an application. Block cloning is susceptible to security risks. For example, if the source file that is being block cloned has an unknown or untrustworthy security status, then block cloning portions of such a source file can corrupt a target file.

### SUMMARY

This disclosure describes computer-implemented methods, computer-readable storage medium, and computer systems to implement secure block cloning on ReFS and more generally on file systems that have resiliency characteristics similar to ReFS.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example of an application implementing a block cloning command on files stored in an example of an ReFS executing an example of a computer security application.

FIG. 2 is a schematic diagram of a workflow implemented by components of the schematic diagram of FIG. 1.

FIG. 3 is a flowchart of an example of a process implemented by components of the schematic diagram of FIG. 1.

FIG. 4 is a block diagram of an example of an endpoint used in the schematic diagram of FIG. 1.

Like reference numbers and designations in the various drawings indicate like elements.

### DETAILED DESCRIPTION

Block cloning is a file copying operation implemented on ReFS. To implement block cloning, ReFS remaps logical clusters, i.e., physical locations on a volume, from a source region to a destination region. ReFS then uses an allocate-on-write mechanism to ensure isolation between those regions. The source and destination regions can be the same or different files. An example of block cloning is shown with reference to the following tables.

Table 1 schematically represent two files, File X and File Y, each having three regions—A, B, C in File X, and D, E, F in File Y. Each file region (i.e., A, B, C for File X or D, E, F for File Y) is stored in a distinct physical region on the volume (e.g., a computer-readable storage medium). In particular, Table 1 schematically represents File X and File Y before block cloning.

TABLE 1
Schematic representation of File X
and File Y before block cloning.

| | | | |
|---|---|---|---|
| File X | A | B | C |
| File Y | D | E | F |

Table 2 shows a mapping of each file region to a respective physical region. Table 2 is maintained by ReFS.

TABLE 2
Mapping of file region to physical region.

| File region | Reference count of physical region |
|---|---|
| A | 1 |
| B | 1 |
| C | 1 |
| D | 1 |
| E | 1 |
| F | 1 |

When an application with access to the ReFS issues a block clone operation from File X, over file regions A and B, to File Y at the offset where file region E currently resides, ReFS implements the block clone operation, following which File X and File Y are modified as schematically shown in Table 3.

TABLE 3
Schematic representation of File X and File Y after block cloning.

| | | | |
|---|---|---|---|
| File X | A | B | C |
| File Y | D | A | B |

Table 4 shows the modified mapping after the block cloning.

TABLE 4
Modified mapping of file region to physical region.

| File region | Reference count of physical region |
|---|---|
| A | 2 |
| B | 2 |
| C | 1 |
| D | 1 |

ReFS duplicated the file regions A and B from File X to File Y by altering the virtual cluster number (VCN) to logical cluster number (LCN) mappings with the ReFS volume (i.e., the physical region in which the file regions are stored). The VCN refers to the number that maps to a corresponding subset of a file. For example, for a 1 MB file with 4 KB clusters, VCN 0 will reference the file subset starting at 0 KB, VCN 1 will reference the file subset starting at 4 KB, VCN 2 will reference the file subset starting at 8 KB, and so on. Logical cluster is the cluster found on the volume and is identifiable by the file system that formats the volume. In particular, ReFS implemented the cloning without reading the physical regions and without overwriting the file regions E and F. In sum, no read or write operation was generated as a result of the block cloning operation.

As mentioned earlier, the block cloning operation was initiated in response to receiving an instruction from an application executing on a computer system operatively coupled to another computer system (i.e., an endpoint) that deploys the ReFS. In some aspects, the endpoint deploying the ReFS also implements a computer security application that monitors and maintains security of the files stored on the ReFS. For example, the computer security application can be any security agent implemented on a virtual machine or physical box server or laptop or similar endpoint. The computer security application can be deployed as a kernel component. The computer security application deploys components that can intercept all commands or instructions received by the endpoint, for example, from other applications requesting to perform operations, such as block cloning, on the ReFS. The computer security application also deploys components that can track, analyze and perform all security-related functions on all the operations, including read operations and write operations, happening on the files that the ReFS stores.

The computer security application evaluates each stored file and associates a trust status with that file. The trust status indicates if a file is clean (or legitimate) and approved for execution, or if the file is bad (or dirty or malicious) and is unapproved for execution. A clean file is one that has a trustworthy reputation. In contrast, a bad file can include malware or a file authored or created by a source with an untrustworthy reputation. Also, a trust status of a file can be determined by calculating a hash (e.g., SHA-256) of the file and checking with a reputation service. If the source file is not trustworthy (in which case, the source file is a bad source file), a file region of a bad source file can be written to a file region of a clean target file, thereby converting the clean target file into a bad file. Therefore, the trust status of the source file needs to be checked prior to implementing the block cloning operation. One technique to check the trust status of the source file is to read the source file, in its entirety, while implementing the block cloning operation. However, reading the source file prior to each instance of block cloning can be time and resource intensive. This disclosure describes a technique to check the trust status of a source file while to block cloning, without reading the entirety of the source file. Implementations have been described using ReFS as an example file system. In general, however, the techniques described here can be implemented using file systems that have resiliency characteristics similar to ReFS. For example, the techniques can be implemented using file systems that manage data through metadata indexing or file systems on which block cloning can be implemented or file systems that combine such features.

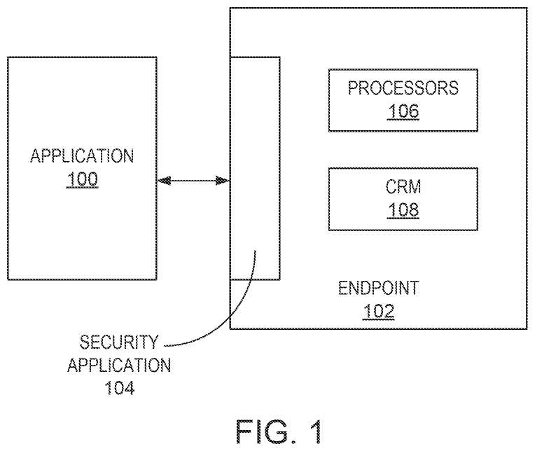

FIG. 1 is a schematic diagram of an example of an application 100 implementing a block cloning command on files stored in an example of an endpoint 102. As described earlier, the endpoint 102 deploys a ReFS on which multiple files are stored. To track and maintain security of the stored files as well as of other operations executable by the endpoint 102, the endpoint 102 also deploys a computer security application 104. The endpoint 102 includes one or more processors 106 and a computer-readable storage medium 108. The storage medium 108 stores computer instructions executable by the one or more processors 106 to perform the operations described here. For example, the computer instructions can include instructions to perform the computer security operations of the computer security application 104.

The computer security application 104 can be a security agent or a sensor running on the endpoint 102 to monitor, detect, and protect against unauthorized activity. In some implementations, such sensors execute with platform specific filter drivers (e.g., drivers that modify the behavior of the sensor to perform the monitoring, detection and protection operations discussed here) and maintain a baseline using which a file is tagged as a “good” file (i.e., a clean or legitimate file that is trustworthy and therefore okay to run) versus a “bad” file (i.e., a dirty or malicious file that is untrustworthy and therefore not okay to run). In some implementations, sensors can be deployed without filter drivers. In the context of this disclosure, a file with an unknown trust status is also considered a bad file.

To maintain the baseline, the filter drivers of the computer security application 104 determine a trust status for all files on the ReFS deployed by the endpoint 102, and store a mapping, for each file, of the trust status and the file. For example, to determine the trust status, the computer security application 104 can determine, for each file, a hash (e.g., the SHA-256 hash) of the file and determine certificate information (i.e., information about the security certificate associated with the file). The certificate information can include an identify of the publisher, a reputation of such a publisher, whether the certificate is valid, when the certificate expires, and similar information. Based on the hash and the certificate information, the computer security application 104 associates a trust status with each file and stores the mapping of the trust status and the file. Such a mapping of the trust status of the multiple files is stored in a base inventory. In some implementations, the computer-readable storage media 108 can store the base inventory. Alternatively, or in addition, the base inventory can be securely stored on separate computer-readable storage media, separate from the computer-readable storage media 108. In this manner, when any computer application, e.g., from the application 100, transmits a command to the endpoint 102, and the command identifies a file stored on the ReFS deployed by the endpoint 102, the computer security application 104 can reference the base inventory to determine a trust status of the file.

In some implementations, when a block cloning command (e.g., FSCTL_DUPLICATE_EXTENTS_TO_FILE command) is received at the endpoint 102, e.g., from the application 100, the computer security application 104 receives (i.e., intercepts) the block cloning command. The block cloning command includes a source file identifier and a target file identifier. The application 100 passes these identifiers and other data or metadata necessary to implement the block cloning command to the endpoint 102. The computer security application 104 intercepts the source file identifier, the target file identifier and any other data or metadata passed to the endpoint 102 through the block cloning command. The computer security application 104 identifies the source file and the target file using the source file identifier and the target file identifier, respectively. In some implementations, the computer security application 104 passes a trust status query command (e.g., FSCTL_GET_INTEGRITY_INFORMATION command) on the source file to the integrity cache. As described earlier, a trust status of each file stored in the ReFS has previously been determined and stored in the base inventory. In response to the trust status query command, the computer security application 104 identifies and retrieves the trust status of the source file and adds this information along with file related information to an integrity cache.

Having identified the trust status of the source file to be block cloned, the computer security application 104 evaluates if the source file is trustworthy. In some implementations, the integrity cache can include an indication that the source file is trustworthy, untrustworthy or has an unknown trust status. Alternatively, the computer security application 104 can determine if the source file is trustworthy, untrustworthy or has an unknown trust status using the retrieved trust status. If the trust status of the source file indicates that the source file is trustworthy, then it can be concluded that the block cloned target file is equally trustworthy. In such instances, the computer security application 104 can assign the trust status of the source file to the target file. To be more specific, the computer security application 104 need not analyze the target file, as described above, to determine the trust status of the block cloned target file. Instead, the computer security application 104 can merely apply the trust status of the source file to the target file.

Conversely, if the trust status of the source file indicates that the source file is not trustworthy, or if the trustworthiness of the source file is unknown or cannot be determined from the trust status, then the computer security application 104 can implement one of a few operations. For example, if the computer security application 104 determines that the source file is untrustworthy, then the computer security application 104 can prevent the block cloning operation from executing. Alternatively, the computer security application 104 can analyze the source file, as described above, to determine the trustworthiness of the source file. The computer security application 104 can pause execution of the block cloning command until the analysis of the source file is complete. Based on the outcome of the analysis, the computer security application 104 can permit the block cloning command to execute or decline to execute the command. After executing the block cloning command, the trust status of the block cloned target file needs to be determined. In such instances, the computer security application 104 can analyze the target file, as described above. That is, the computer security application 104 can calculate a hash of the block cloned target file and identify certificate information associated with the target file to determine a trust status of the target file. The determined trust status can be stored in the integrity cache. Where the computer security application 104 also determines the trustworthiness of the source file, the computer security application 104 can store the trust status of the source file in the integrity cache as well.

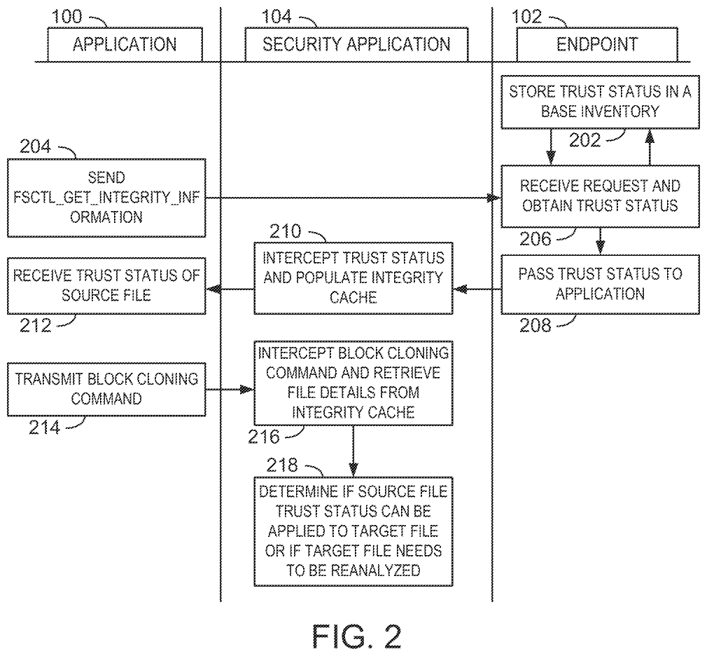

FIG. 2 is a schematic diagram of a workflow implemented by components of the schematic diagram of FIG. 1. At 202, files stored on the ReFS are analyzed, as described above, to determine a trust status of each file. The endpoint 102 stores the trust status of each file in the ReFS in a base inventory. Alternatively, the base inventory is stored separately from the end point 102, e.g., on computer-readable media to which the end point 102 is operatively coupled. At 204, before a block cloning command is issued or while implementing a block cloning command, a FSCTL_GET_INTEGRITY_INFORMATION is sent to obtain a trust status of source file in the block cloning command. For example, the application 100 that transmits the block cloning command to the endpoint 102 can request the trust status of the source file. Alternatively, the application 100 can only transmit the block cloning command, and the computer security application 104, which intercepted the block cloning command, can request the trust status of the source file. At 206, the endpoint 102 receives the request and obtains the trust status of the source file, e.g., by retrieving the trust status from the integrity cache. Table 5 shows the cache entry in response to the trust status query command (e.g., FSCTL_GET_INTEGRITY_INFORMATION command).

TABLE 5
Cache entry in response to the command
requesting trust status of source file.

| Operation | FileTarget | Cache Entry | |
|---|---|---|---|
| FSCTL_GET_INTEG- | Source File | FileObject; | Cache is |
| RITY_INFORMATION | | Filename; | populated |
| | | Filestate; | with |
| | | Entry time | available |
| | | | information |
| | | | when |
| | | | FSCTL |
| | | | command is |
| | | | received |

At 208, the endpoint 102 passes the trust status to the application 100 or to the computer security application 104 or to the component that requested the trust status of the source file. At 210, the computer security application 104 intercepts the trust status of the source file, if the trust status is sent to the application 100, or receives the trust status of the source file, if the trust status is sent to the computer security application 104. If the application 100 had requested the trust status, then, at 212, the application 100 receives the trust status of the source file. At 214, the application 100 transmits the block cloning command, which includes data or metadata to identify the source file, the target file, and, if available, the trust status of the source file. Table 6 shows the cache entry in response to the block cloning command. At 216, the computer security application 104 intercepts the block cloning command and populates the integrity cache with file details including file handle, file object and the like. At 218, the computer security application 104 determines if the trust status of the source file can be applied to the target file (Table 6) or if the target file needs to be reanalyzed.

TABLE 6
Cache entry in response to the command
requesting trust status of source file.

| Operation | FileTarget | Cache Entry | |
|---|---|---|---|
| FSCTL_DUPLICATE_EX- | Target File | FileObject; | Fileobject |
| TENTS_TO_FILE | | Filename; | for source |
| | | Filestate; | file is |
| | | Entry time | identified; |
| | | | Cache is |
| | | | searched |
| | | | using |
| | | | Fileobject; |
| | | | Trust status |
| | | | of source file |
| | | | is propagated |
| | | | to target file. |

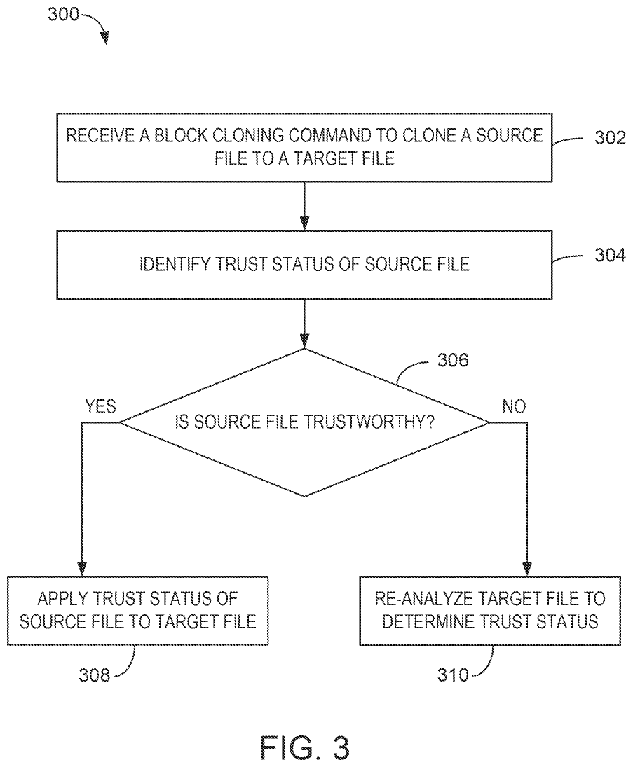

FIG. 3 is a flowchart of an example of a process 300 implemented by components of the schematic diagram of FIG. 1. At 302, a block cloning command to clone a source file to a target file, both stored on ReFS, is received. For example, the computer security application 104 receives the block cloning command from the application 100. At 304, before executing the block cloning command, a trust status associated with the source file is identified. For example, the computer security application 104 identifies the trust status of the source file by looking up the base inventory. At 306, a check if performed to determine if the source file is trustworthy based on the trust status associated with the source file. If the check reveals that the source file is trustworthy (decision branch “YES”), then, at 308, the trust status of the source file is applied to the target file. If the check reveals that the source file is not trustworthy or the trustworthiness of the source file is unknown (decision branch “NO”), then, at 310, if the block cloning command is executed, then the target file is reanalyzed to determine the trust status for the target file.

In some implementations, the application 100 that sends the block cloning command is a backup agent, which opens the source file and sends a trust query (e.g., FSCTL_GET_INTEGRITY_INFORMATION) command on source handle as the first step of block cloning. The computer security application 100 attached to the ReFS monitors all interested file level activity on the files stored by the ReFS. The filter of the computer security application 104 receives the trust query on source file, identifies the trust status from the integrity cache and adds an entry to the trust query. Then, the filter of the computer security application 104 monitors for the block cloning command (e.g., FSCTL_DUPLICATE_EXTENTS_TO_FILE) on target file. When the computer security application 104 receives this information, the application 104 extracts DUPLICATE_EXTENTS_DATA from request to get source handle, and, using the source handle, extracts the source fileobject. Because the fileobject for the source file is already in the integrity cache, the computer security application 104 compares this fileobject and extracts other information such as filename, trust status for the file to determine if the file needs to be reanalyzed. In some aspects, when the source file is closed, the trust status entry is removed from the integrity cache. Alternatively or in addition, the trust status is removed on close/cleanup request. The entry is indexed based on hash and removed synchronously. In some aspects, a time_to_live threshold is attached to the trust status. When the threshold is reached, the trust status is deemed to have expired and is removed. The time_to_live threshold can be configured by a user. In some aspects, if a write operation happens on the source file after the trust status has been determined, then the source file is marked as dirty or bad, and its trust status is removed from the integrity cache. In such instances, the source file can be reanalyzed to determine an updated trust status. Also, in such instances, the filename for this entry can be used to remove other entries present in cache.

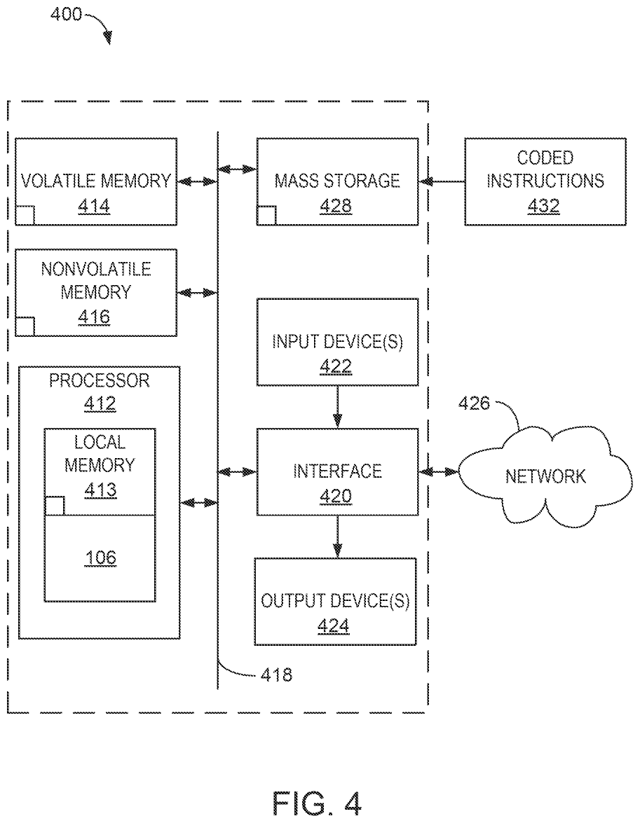

FIG. 4 is a block diagram of an example of an endpoint 400 used in the schematic diagram of FIG. 1. The endpoint 400 can be, for example, a server, a personal computer, a workstation, a self-learning machine (e.g., a neural network), a mobile device (e.g., a cell phone, a smart phone, a tablet computer), a personal digital assistant (PDA), an Internet appliance, or any other type of computing device. In some implementations, the processor 412 implements the components shown in FIG. 1, especially, the manager 102.

The endpoint 400 includes a processor 412, which is hardware. For example, the processor 412 can be implemented by one or more integrated circuits, logic circuits, microprocessors, graphics processing units (GPUs), digital signal processors (DSPs), or controllers. The hardware processor 412 can be a semiconductor, e.g., silicon, based device. The hardware processor 412 can implement the components of the systems (for example, system 100, system 700) described with reference to FIGS. 1 and 2.

The processor 412 includes a local memory 413 (e.g., a cache). The process 412 is in communication with a main memory including a volatile memory 414 and a non-volatile memory 416 via a bus 418. The volatile memory 414 can be implemented by synchronous dynamic random access memory (SDRAM), dynamic random access memory (DRAM) or other type of random access memory device. The non-volatile memory 416 can be implemented by flash memory and/or any other desired type of memory device. A memory controller controls access to the main memory 414, 416.

The endpoint 400 also includes an interface circuit 420 implemented by any type of interface standard, for example, an Ethernet interface, a universal serial bus (USB), a wired or wireless interface, a near field communication (NFC) interface and/or a PCI express interface. One or more input devices 422 are connected to the interface circuit 420. The input devices permit a user to enter data and/or commands to the processor 412. The input devices can be implemented by, for example, an audio sensor, a microphone, a camera (still or video), a keyboard, a button, a mouse, a touchscreen, a track-pad, a trackball, isopoint and/or a voice recognition system.

One or more output devices 424 are also connected to the interface circuit 420. The output devices 424 can be implemented, for example, by display devices, e.g., light emitting diode (LED), an organic LED (OLED), a liquid crystal display (LCD), a cathode ray tube display (CRT), an in-place switching (IPS) display, a touchscreen, etc. and/or a tactile output device, a printer and/or speaker. The interface circuit 420 typically includes a graphics driver card, a graphics driver chip and/or a graphics driver processor.

The interface circuit 420 also includes a communication device such as a transmitter, a receiver, a transceiver, a modem, a residential gateway, a wireless access point, and/or a network interface to facilitate exchange of data with external machines (e.g., computing devices of any kind) via a network 426. The communication can be via, for example, an Ethernet connection, a digital subscriber line (DSL) connection, a telephone line connection, a coaxial cable system, a satellite system, a line-of-site wireless system, a cellular telephone system, etc.

The endpoint 400 also includes one or more mass storage devices 428 for storing software and/or data. Examples of such mass storage devices 428 include floppy disk drives, hard disk drives, compact disk drives, redundant array of independent disks (RAID) systems, digital versatile disk (DVD) drives, or combinations of them.

Machine executable instructions 432 represented by the flowchart of FIG. 4 can be stored in the mass storage device 428, in the volatile memory 414, in the non-volatile memory 416, and/or on a removable non-transitory computer readable storage medium such as a CD or DVD.

Certain aspects of the subject matter described here can be implemented as a computer-implemented method. A computer security application is executed on a computer system deploying a file system configured to implement block cloning on stored files. The computer security application receives a block cloning command to clone a source file to a target file. Before the computer system executes the block cloning command, the computer security application identifies a trust status associated with the source file. The trust status is identified by looking up a base inventory that stores trust data associated with multiple files stored on the file system. The multiple files include the source file. Based on the trust status associated with the source file, the computer security application determines that the trust status associated with the source file is trustworthy. In response to determining that the source file is trustworthy, the computer security application applies the trust status associated with the source file to the target file.

An aspect combinable with any other aspect includes the following features. The source file and the target file are the first source file and the first target file, respectively. The block cloning command is a first block cloning command. The computer security application receives a second block cloning command to clone a second source file to a second target file. Before the computer system executes the second block cloning command, an absence of a trust status associated with the second source file in the base inventory is determined or it is determined that the trust status associated with the second source file is untrustworthy. In response, the second target file is analyzed to determine a trust status for the second target file.

An aspect combinable with any other aspect includes the following features. In response to receiving the block cloning command, the integrity cache populated with the trust data associated with the source file is generated. The integrity cache is also populated with a file hand associated with the source file and a file object associated with the source file.

An aspect combinable with any other aspect includes the following features. To analyze each file of the multiple files, for each file, a hash of each file is determined. Certificate data associated with each file is extracted. The hash of each file and the certificate data are stored in a base inventory.

An aspect combinable with any other aspect includes the following features. The integrity cache is cleared for the source file in response to determining that the source file has been removed from the file system.

An aspect combinable with any other aspect includes the following features. The integrity cache is cleared for the source file in response to determining an expiration of a time to live value associated with the integrity cache for the source file.

An aspect combinable with any other aspect includes the following features. The block cloning command includes a source file identifier identifying the source file and a target file identifier identifying the target file. The source file identifier and the target file identifier are extracted from the block cloning command, and the source file and the target file are identified using the source file identifier and the target file identifier, respectively.

An aspect combinable with any other aspect includes the following features. The block cloning command is transmitted to the file system. To receive the block cloning command, the block cloning command is intercepted before the block cloning command is executed on the file system.

Certain aspects of the subject matter described here can be implemented as a non-transitory computer-readable medium storing instructions which, when executed by a hardware-based processor, perform the methods described here. Certain aspects of the subject matter described here can be implemented as a computer system that includes one or more processors and a non-transitory computer-readable medium storing instructions which, when executed by the one or more processors, perform the methods described here.

While this specification contains many specific implementation details, these should not be construed as limitations on the scope of any implementation or on the scope of what may be claimed, but rather as descriptions of features that may be specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In certain implementations, multitasking and parallel processing can be advantageous

What is claimed is:

1. A computer-implemented method comprising:
receiving, by a computer security application executing on a computer system deploying a file system configured to implement block cloning on stored files, a block cloning command to clone a source file to a target file;
before the computer system executes the block cloning command:
identifying, by the computer security application, a trust status associated with the source file, the trust status identified by looking up a base inventory that stores trust data associated with a plurality of files stored on the file system, the plurality of files including the source file, and
determining, based on the trust status associated with the source file, that the trust status associated with the source file is trustworthy; and
in response to determining that the source file is trustworthy, applying the trust status associated with the source file to the target file.

2. The method of claim 1, wherein the source file and the target file are the first source file and the first target file, respectively, wherein the block cloning command is a first block cloning command, wherein the method further comprises:
receiving a second block cloning command to clone a second source file to a second target file; and
before the computer system executes the second block cloning command:
determining an absence of a trust status associated with the second source file in the base inventory or that the trust status associated with the second source file is untrustworthy, and
in response to determining the absence of the trust status associated with the second source file in the base inventory, analyzing the second target file to determine a trust status for the second target file.

3. The method of claim 1, further comprising, before in response to receiving the block cloning command, generating the integrity cache that stores populated with the trust data associated with the plurality of filessource file, a file handle associated with the source file, and a file object associated with the source file stored on the file system by analyzing each file of the plurality of files.

4. The method of claim 3, wherein analyzing each file of the plurality of files comprises, for each file:
determining a hash of each file;
extracting certificate data associated with each file;
storing, in a base inventory, the hash of each file and the certificate data associated with each file.

5. The method of claim 1, further comprising clearing the integrity cache for the source file in response to determining that the source file has been removed from the file system.

6. The method of claim 1, further comprising clearing the integrity cache for the source file in response to determining an expiration of a time to live value associated with the integrity cache for the source file.

7. The method of claim 1, wherein the block cloning command includes a source file identifier identifying the source file and a target file identifier identifying the target file, wherein the method further comprises:
extracting the source file identifier and the target file identifier from the block cloning command; and
identifying the source file and the target file using the source file identifier and the target file identifier, respectively.

8. The method of claim 1, wherein the block cloning command is transmitted to the file system, wherein receiving the block cloning command comprises intercepting the block cloning command before the block cloning command is executed on the file system.

9. A non-transitory computer-readable medium storing instructions which, when executed by a hardware-based processor, performs operations comprising:
receiving, by a computer security application executing on a computer system deploying a file system configured to implement block cloning on stored files, a block cloning command to clone a source file to a target file;
before the computer system executes the block cloning command:
identifying, by the computer security application, a trust status associated with the source file, the trust status identified by looking up a base inventory that stores trust data associated with a plurality of files stored on the file system, the plurality of files including the source file, and
determining, based on the trust status associated with the source file, that the trust status associated with the source file is trustworthy; and
in response to determining that the source file is trustworthy, applying the trust status associated with the source file to the target file.

10. The medium of claim 9, wherein the source file and the target file are the first source file and the first target file, respectively, wherein the block cloning command is a first block cloning command, wherein the operations further comprise:
receiving a second block cloning command to clone a second source file to a second target file; and
before the computer system executes the second block cloning command:
determining an absence of a trust status associated with the second source file in the integrity cache or that the trust status associated with the second source file is untrustworthy, and
in response to determining the absence of the trust status associated with the second source file in the integrity cache, analyzing the second target file to determine a trust status for the second target file.

11. The medium of claim 9, wherein the operations further comprise, in response to receiving the block cloning command, generating the integrity cache that populated with the trust data associated with the source file, a file handle associated with the source file, and a file object associated with the source file.

12. The medium of claim 11, wherein analyzing each file of the plurality of files comprises, for each file:
determining a hash of each file;
extracting certificate data associated with each file;
storing, in a base inventory, the hash of each file and the certificate data associated with each file.

13. The medium of claim 9, wherein the operations further comprise clearing the integrity cache for the source file in response to determining that the source file has been removed from the file system.

14. The medium of claim 9, wherein the operations further comprise clearing the integrity cache for the source file in response to determining an expiration of a time to live value associated with the integrity cache for the source file.

15. The medium of claim 9, wherein the block cloning command includes a source file identifier identifying the source file and a target file identifier identifying the target file, wherein the operations further comprise:
extracting the source file identifier and the target file identifier from the block cloning command; and
identifying the source file and the target file using the source file identifier and the target file identifier, respectively.

16. The medium of claim 9, wherein the block cloning command is transmitted to the file system, wherein receiving the block cloning command comprises intercepting the block cloning command before the block cloning command is executed on the file system.

17. A system comprising:
one or more processors including a hardware-based processor; and
a memory storage including a non-transitory computer-readable medium storing instructions which, when executed by the one or more processors including the hardware-based processor, performs operations comprising:
receiving, by a computer security application executing on a computer system deploying a file system configured to implement block cloning on stored files, a block cloning command to clone a source file to a target file;
before the computer system executes the block cloning command:
identifying, by the computer security application, a trust status associated with the source file, the trust status identified by looking up a base inventory that stores trust data associated with a plurality of files stored on the file system, the plurality of files including the source file, and
determining, based on the trust status associated with the source file, that the trust status associated with the source file is trustworthy; and
in response to determining that the source file is trustworthy, applying the trust status associated with the source file to the target file.

18. The system of claim 17, wherein the source file and the target file are the first source file and the first target file, respectively, wherein the block cloning command is a first block cloning command, wherein the operations further comprise:
receiving a second block cloning command to clone a second source file to a second target file; and
before the computer system executes the second block cloning command:
determining an absence of a trust status associated with the second source file in the integrity cache or that the trust status associated with the second source file is untrustworthy, and
in response to determining the absence of the trust status associated with the second source file in the integrity cache, analyzing the second target file to determine a trust status for the second target file.

19. The system of claim 17, wherein the operations further comprise, before in response to receiving the block cloning command, generating the integrity cache that stores populated with the trust data associated with the plurality of filessource file, a file handle associated with the source file, and a file object associated with the source file stored on the file system by analyzing each file of the plurality of files.

20. The system of claim 19, wherein analyzing each file of the plurality of files comprises, for each file:
determining a hash of each file;
extracting certificate data associated with each file;
storing, in the a integrity cachebase inventory, the hash of each file, and the certificate data associated with each file, a file handle associated with each file, and a file object associated with each file.
